(19) United States
(12) Patent Application Publication
(10) Pub. No.: US 2010/0025125 A1
(43) Pub. Date: Feb. 4, 2010

(54) Method and Apparatus for the Operation of a Vehicle

(75) Inventors: Reyk Bienert, Renningen (DE); Alfred Jeckel, Bloomfield Hills, MI (US)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 12/184,913

(22) Filed: Aug. 1, 2008

(51) Int. Cl. B60K 11/00; F25B 1/00; H01M 10/50

(52) U.S. Cl. 180/65.1; 62/498; 429/120

(57) ABSTRACT

In a method and apparatus for the operation of a vehicle having a battery with a plurality of series or parallel connected individual cells, a coolant flows through the respective cell housings and/or a battery housing that encloses the entire battery. The coolant is delivered within a coolant circuit by a pump unit, and is thermally coupled with a refrigerant circuit through a heat exchanger. A refrigeration compressor placed in the refrigerant circuit is thermally coupled with the coolant circuit through the heat exchanger, depending on a current ambient temperature and/or a current speed of the vehicle. The speed of the refrigeration compressor may be regulated depending on the current ambient temperature and/or the current speed of the vehicle.

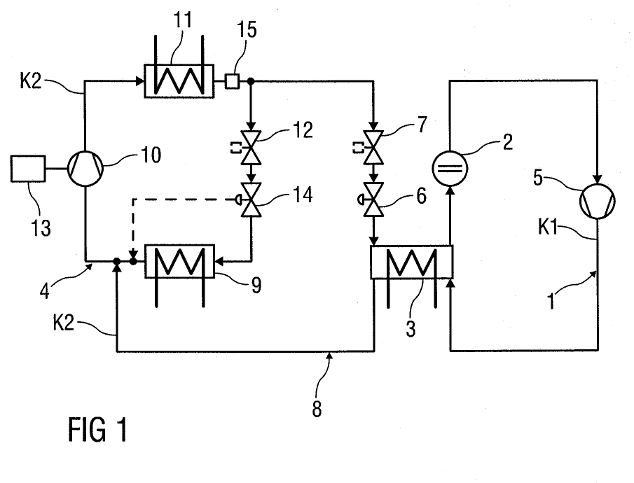

### BACKGROUND AND SUMMARY OF THE INVENTION

The present invention relates to a method and apparatus for operating a vehicle having a battery with a plurality of individual parallel or series connected cells.

Batteries for vehicle applications, particularly for hybrid vehicles, conventionally have a plurality of individual cells, which are connected in series and/or in parallel, and are usually located together with an associated electronic system and apparatus for cooling in a joint battery housing. Different methods and apparatus for cooling are known from prior art, including, for example, indirect cooling by integrating the battery into a refrigerant circuit of a vehicle air conditioning system, or direct cooling of the individual cells by precooled air that is channeled between the cells.

Cooling with the air conditioning circuit is used preferably due to installation space considerations. In it, a heat conducting plate, through which there flows a heat conducting medium (hereafter referred to as coolant), is placed on the cell structure formed by the individual cells. Such a battery cooled this way, with a heat conducting plate to keep the battery at a constant temperature, is disclosed in German patent document DE 10 2007 010 739.2. The battery features several parallel and/or series connected individual cells that are joined with the heat conducting plate and conduct heat. A duct structure through which the coolant can flow is placed in the heat conducting plate, and the heat conducting plate has lead-through terminal cross-sections for the duct structure at its disposal. The heat conducting plate features holes in the area of the terminals of the individual cells, and the terminals of the individual cells project through the holes. For the thermal coupling of the battery with the refrigerant circuit of the vehicle air conditioning system, a heat exchanger can be provided, for example.

During a vehicle drive at low ambient temperatures, an air-mass flow generated by the airflow is sufficient with the heat exchanger to dissipate the lost heat generated by the battery. However, at low vehicle speeds (for example, during vehicle standstill phases), or high outdoor temperatures, the air-mass flow with the heat exchanger is no longer sufficient, so that improved heat dissipation can be achieved by means of a thermal coupling with the refrigerant circuit of the air conditioning system.

German patent document DE 197 14 501 A1 discloses such a compression-refrigerant circuit of an air conditioning system, particularly for a motor vehicle with a measure for influencing a refrigerant pressure, particularly a pressure level upstream of the compressor, depending on at least one boundary condition. As a boundary condition, pressure oscillations in the refrigerant circuit can be detected with a vibration pick-up and can be reduced with the appropriate measure. For example, an extent of a recooling of the refrigerant in a condenser can be reduced, or the refrigerant is heatable. Moreover, it is possible to increase the mass flow rate of the refrigerant, with an expansion valve that detects pressure oscillations, with longer opening periods of the valve.

However, during the cooling of the battery with such a refrigerant circuit, excessive refrigerant cooling can occur in the condenser, particularly at temperatures under 0° C. Thus, this system has the disadvantage that supercooling of the refrigerant after the condenser is not feasible, and therefore thermodynamic cooling may not occur. Additionally, at low ambient temperatures, the air in a passenger cell of the vehicle is also often cool or is heated, so that the heat input into the refrigerant of the vehicle air conditioning system is very low. It is therefore possible that the heat input may not be sufficient to evaporate the refrigerant, and adverse operating conditions may occur in the vehicle air conditioning system exists.

The object of the present invention, therefore, is to provide an improved method and apparatus for operating a vehicle having a battery with several individual cells connected with each other in parallel and/or series.

Another object of the invention is to provide such a method and apparatus which can achieve efficient cooling of the battery at different ambient temperatures and vehicle speeds.

These and other objects and advantages are achieved by the method according to the present invention, in which a coolant flows through the respective housing of the cells and/or through a battery housing enclosing everything. The coolant is delivered within a coolant circuit by a pump unit, and the coolant circuit is thermally coupled with a refrigerant circuit through a heat exchanger. According to the invention, a refrigeration compressor placed in the refrigerant circuit is thermally coupled with the coolant circuit through the heat exchanger depending on a current ambient temperature and/or a current speed of the vehicle, and a speed of the refrigeration compressor is regulated depending on the current ambient temperature and/or the current speed of the vehicle.

In this process, the current ambient temperature is compared with a preset ambient temperature threshold, and/or the current speed is compared with a preset speed threshold. According to an advantageous embodiment of the invention, the refrigerant circuit is then coupled with the coolant circuit if the current ambient temperature and/or the current speed of the vehicle fall below the applicable threshold. According to a further advantageous feature of the invention, the speed of the refrigeration compressor may then be increased if the current ambient temperature and/or the current speed of the vehicle fall below such threshold.

As a result, sufficient cooling of the battery is ensured, both at high and low ambient temperatures, and at high and low vehicle speeds.

In addition, the speed of the refrigeration compressor is increased particularly when the ambient temperature falls below the ambient temperature threshold and/or the speed falls below the speed threshold, so that effective cooling of the refrigerant in the condenser is also achieved at low speeds and/or standstill phases of the vehicle, while avoiding excessive cooling of the refrigerant in the condenser. Accordingly, supercooling of the refrigerant after the condenser, as required for the thermodynamic cooling process, is feasible.

According to another advantageous feature of the invention, it is also possible to regulate the speed of the refrigeration compressor in a pulsating manner.

Furthermore, the heat exchanger may be coupled with the refrigerant circuit by means of a shutoff valve placed upstream of the heat exchanger in the direction of flow, thereby simply and reliably integrating the heat exchanger into the refrigerant circuit.

In an embodiment of the present invention, an evaporator placed in the refrigerant circuit is then uncoupled from the refrigerant circuit, with another shutoff valve placed upstream of the evaporator in the direction of flow if the heat exchanger, which is coupled with the refrigerant circuit. This way, the function of the evaporator is replaced by the heat exchanger so that the refrigerant can always be supplied with sufficient heat energy for evaporation.

To monitor the thermodynamic cooling process, and in an advantageous manner according to an embodiment of the present invention, the pressure of the refrigerant is captured in the refrigerant circuit with a pressure sensor placed after the condenser in the direction of flow, and a plausibility test is carried out with the detected pressure.

The apparatus for operating a vehicle according to the invention, a coolant can flow through the respective housings of the cells and/or through a battery housing enclosing everything. A pump unit delivers the coolant within a coolant circuit, which can be thermally coupled with a refrigerant circuit through a heat exchanger. According to the invention, a refrigeration compressor placed in the refrigerant circuit can be coupled with the coolant circuit through a heat exchanger depending on a current ambient temperature and/or a current speed of the vehicle. A controller can control the speed of the refrigeration compressor depending on the current ambient temperature and/or the current speed of the vehicle.

Other objects, advantages and novel features of the present invention will become apparent from the following detailed description of the invention when considered in conjunction with the accompanying drawings.

### BRIEF DESCRIPTION OF THE DRAWINGS

The single FIGURE of the drawing shows, schematically, a coolant circuit with a battery placed in it and a refrigerant circuit coupled with the coolant circuit through a heat exchanger.

### DETAILED DESCRIPTION OF THE DRAWINGS

Referring to the FIGURE a coolant circuit 1 is coupled with a battery 2, and a refrigerant circuit 4 is coupled with the coolant circuit 1 through a heat exchanger 3. Both the method according to the invention and the apparatus according to the invention, and embodiments thereof, are explained in more detail with the shown arrangement.

The battery 2 is a high-voltage battery, such as is provided, for example, for a vehicle with a hybrid drive and/or for a vehicle operated with fuel cells (particularly, a passenger vehicle). The battery 2 is composed of a plurality of individual cells connected with each other in parallel and/or series (not shown), which are preferably placed as a cell structure in a battery housing.

Since such batteries 2 generate a large heat loss during operation (particularly during the charging or discharging), the battery 2 is thermally coupled with the coolant circuit 1. For this purpose, a coolant K1 is conveyed in the coolant circuit 1 can flow through the battery housing and/or a housing of the individual cells. Coolant K1 delivered by a pump unit 5 that is disposed in the coolant circuit 1, absorbs the lost heat of the battery 2, and delivers it in the heat exchanger 3 (for example, a chiller or an evaporator).

Coolant circuit 1 is, according to the shown embodiment of the present invention, a separate coolant circuit 1; the coolant circuit 1, according to further embodiments of the present invention that are not shown in greater detail, can be, for example, a component part of an engine cooling circuit as well.

To achieve increased heat dissipation, the coolant circuit 1 is coupled with the refrigerant circuit 4 through the heat exchanger 3. Such coupling can be implemented permanently or only in case of an increased heat dissipation demand, as is the case, for example, in vehicle standstill phases, with a shutoff valve 6 placed upstream of the heat exchanger 3 in the direction of flow, so that the heat exchanger 3 and the coolant circuit 1 are connected in parallel to the refrigerant circuit 4.

With a heat exchanger circuit 8 including the heat exchanger 3, the shutoff valve 6, and an expansion valve 7 placed upstream of the shutoff valve 6 in the flow direction, improved heat dissipation of lost heat from the battery 2 is achieved through coolant K1 and a refrigerant K2 in the refrigerant circuit 4.

The refrigerant circuit 4 may be, for example, a refrigerant circuit of a vehicle air condition system, and refrigerant K2 in the refrigerant circuit 4 is fed, in a liquid state at low pressure, to an evaporator 9, and is evaporated with the utilization of a temperature of an air to be cooled in a passenger cell. During this process, the temperature of refrigerant K2 is increased.

The vaporous refrigerant K2 is then fed to a refrigeration compressor 10, which compresses it with a pressure increase, and a related temperature increase, and feeds it to a condenser 11. In the condenser 11, the refrigerant K2 is cooled and liquefied by an ambient air of the vehicle, for example. Thereafter, the refrigerant K2 is fed to an expansion valve 12, where it is expanded, with a further decrease in temperature, and then fed into the evaporator 9 again.

During a vehicle drive, at low ambient temperature (particularly at temperatures below 0° C.), there is, however, the risk, due to a vehicle speed-dependent air-mass flow through condenser 11, that the cooling of refrigerant K2 in the condenser is so strong that no further supercooling of the refrigerant K2 can take place in expansion valve 12, and thus the thermodynamic cooling process cannot occur.

As already explained, the battery 2 generates a large heat loss, particularly during charging and discharging. During a constant vehicle drive, for example, a vehicle with a hybrid drive, the heat generation of the battery 2 is relatively small due to operation strategy of the vehicle. In city traffic or in stop-and-go operation of the vehicle, however, the generated lost heat can be very high, since the battery 2 is discharged due to the use of an electric motor and/or is charged during a recovery of brake energy. Increased heat dissipation from the battery 2 is thus necessary during slow drives or standstill phases of the vehicle.

For these reasons, the method according to the present invention provides for a refrigeration compressor 10 that is placed in the refrigerant circuit 4 to be thermally coupled with the coolant circuit 1 through a heat exchanger 3 depending on a current ambient temperature and/or a current speed of the vehicle, and a speed of the refrigeration compressor 10 is regulated depending on the current ambient temperature and/or the current speed of the vehicle.

In this process, the current ambient temperature is compared with a present ambient temperature threshold and/or the current speed is compared with a preset speed threshold. According to an advantageous embodiment of the invention, the refrigerant circuit is then coupled with the coolant circuit if the current ambient temperature and/or the current speed of the vehicle fall below an ambient temperature threshold and/or a speed threshold.

In order to adapt the heat dissipation through the refrigerant circuit to the lost heat generation of the battery 2, the refrigerant circuit K4 is preferably thermally coupled with the coolant circuit 1 when the speed falls below the speed threshold. Since increased heat dissipation is necessary at higher ambient temperatures, the refrigerant circuit 4 is additionally thermally coupled with the coolant circuit 1 if the ambient temperature exceeds the ambient temperature threshold.

Since additional cooling of the battery 2 is also necessary at low ambient temperatures, while excessively cooling of the refrigerant K2 in the condenser 11 must be avoided for the reasons mentioned previously, in an especially advantageous embodiment of the invention, the speed of the refrigeration compressor 10 is increased if the ambient temperature falls below the ambient temperature threshold and/or the speed falls below the speed threshold. Thus, excessive heat output of refrigerant K2 on the condenser 11 is avoided.

In an embodiment of the invention, the speed of the refrigeration compressor 10 can also be regulated in a pulsating manner.

The speed threshold and the ambient temperature threshold can be specified as a function of the arrangement of the battery 2 in the vehicle, the technical properties of the battery 2, and of other design-engineering specifications. For example, the speed threshold can be 30 km/h and the ambient temperature threshold 0° C. or 2° C. However, higher or lower values can also be specified.

In order to assure that sufficient heat energy is provided to the refrigerant K2 for evaporation, the evaporator 9 in the refrigerant circuit 4 is then uncoupled from the refrigerant circuit K2 with another shutoff valve 14 that is placed upstream of the evaporator 9 (in the direction of flow if the heat exchanger 3) which is coupled with the refrigerant circuit 4. This way, the function of the evaporator 9 is replaced by the heat exchanger 3.

The expansion and further cooling of the refrigerant K2 is, in this case, carried out with the expansion valve 7 that is placed before the heat exchanger 3 in the direction of flow.

In order to monitor the thermodynamic cooling process, and in an advantageous manner according to an advantageous embodiment of the present invention, the pressure of the refrigerant K2 is captured in the refrigerant circuit 4 with a pressure sensor 15 placed between the condenser 11 and the expansion valve 7 or 12, and a plausibility test is carried out with the detected pressure.

According to a further advantageous embodiment of the invention, alternatively the coolant circuit 1 can be coupled directly with the refrigerant circuit 4, for example with another shutoff valve (not shown), depending on the current ambient temperature and/or the current speed of the vehicle. In this case, the refrigerant K2 and the coolant K1 are composed of the same heat conducting medium.

In summary, the method and apparatus according to the invention make it possible to achieve the advantages of a liquid cooling in comparison to an air cooling of the battery 2. That is, it is possible to achieve independence from a temperature of the air in the passenger compartment, improved installation space situation, and better noise characteristics. At the same time, and in an especially gainful manner, a uniform cooling performance is achieved at different vehicle speeds and ambient air temperatures.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### List of Reference Numerals

1 Coolant circuit
2 Battery
3 Heat exchanger
4 Refrigerant circuit
5 Pump unit
6 Shutoff valve
7 Expansion valve
8 Heat exchanger circuit
9 Evaporator
10 Refrigeration compressor
11 Condenser
12 Expansion valve
13 Controller
14 Shutoff valve
15 Pressure sensor
K1 Coolant
K2 Refrigerant

What is claimed is:

1. A method for operating a vehicle that includes a battery having a plurality of series or parallel connected individual cells, with a coolant that flows through respective housings of the cells or a housing of the battery, wherein:
the coolant is delivered by a pump unit within a coolant circuit;
the coolant circuit is thermally coupled with a refrigeration circuit through a heat exchanger;
a refrigeration compressor is included in the refrigerant circuit;
the refrigeration compressor is thermally coupled with, or uncoupled from, the coolant circuit through the heat exchanger, depending on at least one of a current ambient temperature and a current speed of the vehicle; and
the speed of the refrigeration compressor is regulated depending on at least one of the current ambient temperature and the current speed of the vehicle.

2. The method according to claim 1, wherein at least one of the following is true:
the current ambient temperature is compared with a present ambient temperature threshold; and
the current vehicle speed is compared with a preset speed threshold.

3. The method according to claim 1, wherein the refrigerant circuit is then coupled with the coolant circuit if at least one of the following is true:
the current ambient temperature falls below an ambient temperature threshold; and
the current vehicle speed falls below a speed threshold.

4. A method according to claim 1, wherein speed of the refrigeration compressor is increased if at least one of the following is true:
the current ambient temperature falls below an ambient temperature threshold; and
the current vehicle speed falls below a speed threshold.

5. The method according to claim 1, wherein the speed of the refrigeration compressor is regulated in a pulsating manner.

6. The method according to claim 1, wherein the heat exchanger is coupled with the refrigerant circuit through a shutoff valve situated upstream of the heat exchanger relative to a direction of flow.

7. The method according to claim 1, wherein an evaporator in the refrigerant circuit is uncoupled from the refrigerant circuit via another shutoff valve situated upstream of the evaporator relative to a direction of flow if the heat exchanger is coupled with the refrigerant circuit.

8. The method according to claim 1, wherein:
a pressure of the refrigerant is captured by a pressure sensor in the refrigerant circuit, downstream of the condenser relative to a direction of flow; and
a plausibility test is carried out with the detected pressure.

9. Apparatus for operation of a vehicle that includes a battery having a plurality of series or parallel connected individual cells, with a coolant that flows through respective housings of the cells or a housing of the battery, wherein:
a pump unit delivers the coolant within a coolant circuit that is connectable with a refrigerant circuit through a heat exchanger;
a refrigeration compressor is provided in the refrigerant circuit;
the refrigeration compressor is thermally coupled with, or uncoupled from, the coolant circuit through the heat exchanger, depending on one of a current ambient temperature and a current speed of the vehicle; and
a controller controls the speed of the refrigeration compressor depending on at least one of the current ambient temperature and the current speed of the vehicle is provided.

10. The apparatus according to claim 9, wherein the heat exchanger is a chiller or an evaporator.

11. The apparatus according to claim 9, wherein the battery, the pump unit, and the heat exchanger are disposed in the coolant circuit.

12. The apparatus according to claim 9, wherein a refrigeration compressor, a condenser, an expansion valve, a shutoff valve, and an evaporator are provided in the refrigerant circuit.

13. The apparatus according to claim 12, wherein the shutoff valve is provided for an uncoupling of the evaporator from the refrigerant circuit.

14. The apparatus according to claim 9, wherein:
the heat exchanger, an expansion valve, and a shutoff valve are provided in a heat exchanger circuit; and
the shutoff valve is provided for the coupling of the cooling circuit and the refrigerant circuit through the heat exchanger.

15. The apparatus according to claim 9, wherein:
a pressure sensor is provided in the refrigeration circuit, downstream of the condenser relative to the direction of flow; and
a pressure of the refrigerant is ascertainable with said pressure sensor.

16. The apparatus according to claim 9, wherein the refrigerant and the coolant comprise the same heat conducting medium.
